(19) United States
(12) Patent Application Publication
(10) Pub. No.: US 2025/0093759 A1
(43) Pub. Date: Mar. 20, 2025

(54) LIGHT HOMOGENIZING MODULE AND PROJECTION DEVICE

(71) Applicant: Coretronic Corporation, Hsin-Chu (TW)

(72) Inventors: Ming-Feng Hou, Hsin-Chu (TW); Shi-Wen Lin, Hsin-Chu (TW)

(73) Assignee: Coretronic Corporation, Hsin-Chu (TW)

(21) Appl. No.: 18/884,039

(22) Filed: Sep. 12, 2024

(30) Foreign Application Priority Data
Sep. 18, 2023 (CN) 202311198240.2

(51) Int. Cl. G03B 21/20

(52) U.S. Cl. CPC G03B 21/208

(57) ABSTRACT

A light homogenizing module, including a light homogenizing element and a light shielding element, is provided. The light homogenizing element includes a light incident surface and an axis perpendicular to the light incident surface. The light shielding element is disposed on a side of the light incident surface. The light shielding element includes a first reflection portion, at least one second reflection portion, and a light entrance. The first reflection portion surrounds the light entrance. The second reflection portion has a first end portion and a second end portion opposite to each other. The first end portion is connected to the first reflection portion. The second end portion is farther away from the light homogenizing element than the first reflection portion. The light entrance exposes the light incident surface. An extension direction of the first reflection portion is parallel to the light incident surface.

### CROSS-REFERENCE TO RELATED APPLICATION

This application claims the priority benefit of China application serial no. 202311198240.2, filed on Sep. 18, 2023. The entirety of the above-mentioned patent application is hereby incorporated by reference herein and made a part of this specification.

### BACKGROUND

### Technical Field

The disclosure relates to a light homogenizing module and a projection device.

### Description of Related Art

The projection device is a display device used to generate a large-size image. With the evolution and innovation of technology, the projection device is constantly improving. The imaging principle of the projection device is to convert an illumination beam generated by an illumination system into an image beam by a light valve, and then project the image beam through a projection lens onto a projection target (for example, a screen or wall) to form a projection image. In addition, following the market requirements such as brightness, color saturation, service life, and non-toxic and environmentally friendly to the projection device, the illumination system has also evolved from the ultra-high-performance lamp (UHP lamp) and the light emitting diode (LED) to the most advanced laser diode (LD) light source. There is even the emergence of the packaged light source formed by the all-in-one laser diode that can provide a single-color or multi-color light beam, so that the internal configuration of the projection device is more compact and the optical performance is better.

In the current light combining system, higher energy light sources are used following the requirement for increased brightness, which causes optical elements in the light path to absorb more heat as the energy increases, causing the temperatures of the optical elements to increase along with the system brightness, and cracking occurs after a certain period of use. Therefore, in order to solve the above situation, integration rod covers may be disposed in front and at the back of the integration rod to block a part of the light rays, so as to reduce the formation of stray light. In addition, most of the current integration rod covers are made of sheet metal, and the surfaces have partially reflective properties, so a part of the light rays is reflected back into the optical path of the system. Although the formation of stray light can be reduced, the optical elements in the original optical path may be damaged due to increased temperature from absorbing more energy.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The disclosure provides a light homogenizing module, which includes a light homogenizing element and a light shielding element. The light homogenizing element includes a light incident surface and an axis perpendicular to the light incident surface. The light shielding element is disposed on a side of the light incident surface. The light shielding element includes a first reflection portion, at least one second reflection portion, and a light entrance. The first reflection portion surrounds a light entrance. The at least one second reflection portion has a first end portion and a second end portion opposite to each other. The first end portion of the at least one second reflection portion is connected to the first reflection portion, and the second end portion of the at least one second reflection portion is farther away from the light homogenizing element than the first reflection portion. The light entrance exposes the light incident surface. An extension direction of the first reflection portion is parallel to the light incident surface, and in a direction parallel to the light incident surface, a distance between the second end portion of the at least one second reflection portion and the axis is less than or equal to a distance between the first end portion of the at least one second reflection portion and the axis.

The disclosure also provides a projection device, which includes an illumination system, at least one light valve, and a projection lens. The illumination system is used to provide an illumination beam. The at least one light valve is disposed on a transmission path of the illumination beam from the illumination system and is used to convert the illumination beam into an image beam. The projection lens is disposed on a transmission path of the image beam and is used to project the image beam out of the projection device. The illumination system includes a light source module and a light homogenizing module. The light source module is used to provide the illumination beam. The light homogenizing module is disposed on the transmission path of the illumination beam and is used to receive and homogenize the illumination beam. The light homogenizing module includes a light homogenizing element and a light shielding element. The light homogenizing element includes a light incident surface and an axis perpendicular to the light incident surface. The light shielding element is disposed on a side of the light incident surface. The light shielding element includes a first reflection portion, at least one second reflection portion, and a light entrance. The first reflection portion surrounds the light entrance. The at least one second reflection portion has a first end portion and a second end portion opposite to each other. The first end portion of the at least one second reflection portion is connected to the first reflection portion, and the second end portion of the at least one second reflection portion is farther away from the light homogenizing element than the first reflection portion. The light entrance exposes the light incident surface. An extension direction of the first reflection portion is parallel to the light incident surface, and in a direction parallel to the light incident surface, a distance between the second end portion of the at least one second reflection portion and the axis is less than or equal to a distance between the first end portion of the at least one second reflection portion and the axis.

Other objectives, features and advantages of the disclosure will be further understood from the further technological features disclosed by the embodiments of the disclosure wherein there are shown and described preferred embodiments of this disclosure, simply by way of illustration of modes best suited to carry out the disclosure.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic view of a projection device according to an embodiment of the disclosure.

FIG. 2 and FIG. 3 are respectively schematic views of a light homogenizing module at different viewing angles according to an embodiment of the disclosure.

FIG. 4A is a schematic cross-sectional view of a light homogenizing module according to an embodiment of the disclosure.

FIG. 4B is a schematic cross-sectional view of a light homogenizing module according to another embodiment of the disclosure.

FIG. 5 is a schematic cross-sectional view of a light homogenizing module according to another embodiment of the disclosure.

FIG. 6 is a schematic cross-sectional view of a light homogenizing module according to another embodiment of the disclosure.

FIG. 7 is a schematic cross-sectional view of a light homogenizing module according to another embodiment of the disclosure.

### DETAILED DESCRIPTION OF DISCLOSED EMBODIMENTS

In the following detailed description of the preferred embodiments, reference is made to the accompanying drawings which form a part hereof, and in which are shown by way of illustration specific embodiments in which the disclosure may be practiced. In this regard, directional terminology, such as “top”, “bottom”, “front”, “back”, etc., is used with reference to the orientation of the FIG. (s) being described. The components of the disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the disclosure. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings. Similarly, the terms “facing”, “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

Embodiments of the disclosure provide a light homogenizing module and a projection device, which can reduce the degree of energy absorption of an optical element in an illumination system to lower the temperature of the optical element and increase the service life. In addition, other objectives and advantages of the disclosure can be further understood from the technical features of the disclosure.

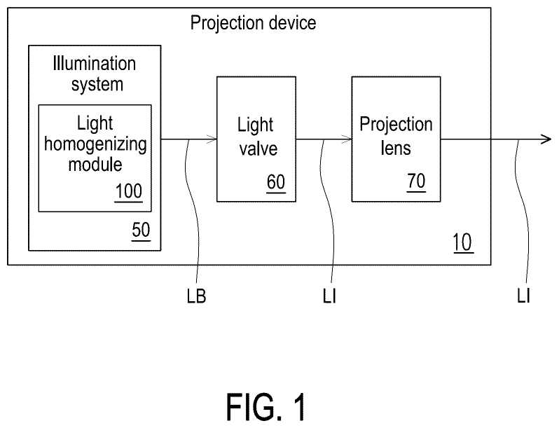

FIG. 1 is a schematic view of a projection device according to an embodiment of the disclosure. Please refer to FIG. 1. The embodiment provides a projection device 10, which includes an illumination system 50, at least one light valve 60, and a projection lens 70. The illumination system 50 is used to provide an illumination beam LB. The at least one light valve 60 is disposed on a transmission path of the illumination beam LB from the illumination system 50 to convert the illumination beam LB into an image beam LI. The projection lens 70 is disposed on a transmission path of the image beam LI and is used to project the image beam LI out of the projection device 10 onto a projection target (not shown), such as a screen or a wall.

The illumination system 50 is, for example, composed of multiple elements such as a light emitting element, a light splitting element, a light combining element, a lens element, a wavelength conversion element, a filter element, and a light homogenizing element. Light emitted by the light emitting element is used to provide light of different wavelengths after passing through the filter element to form the illumination beam LB, and the illumination beam LB is homogenized by the light homogenizing element and then leaves the illumination system 50. In other embodiments, the illumination system 50 may not be provided with the filter element, the light of different wavelengths is generated by other optical elements to form the illumination beam LB, and the illumination beam LB is homogenized by the light homogenizing element and then leaves the illumination system 50. For example, in the embodiment, the illumination system 50 includes a light source module (not shown) and a light homogenizing module 100. The light source module is used to provide the illumination beam LB, and the light homogenizing module 100 is disposed on the transmission path of the illumination beam LB and is used to receive and homogenize the illumination beam LB. The light source module may include multiple light emitting elements, such as multiple light emitting diodes (LEDs) or multiple laser diodes (LDs). The illumination beam LB may include multiple light beams of different wavelengths combined or a light beam of at least one wavelength, wherein the light beams of different wavelengths may be respectively output from the illumination system 50 as the illumination beam LB at different timings. However, the disclosure is not limited thereto. The detailed implementation of the light homogenizing module 100 will be described later, and the disclosure does not limit the type or the form of the illumination system 50 in the projection device 10. Therefore, sufficient teachings, suggestions, and implementation descriptions of the remaining detailed structures and implementations of the illumination system 50 may be obtained from common knowledge in the art, so there will be no reiteration.

The light valve 60 is, for example, a reflective light modulator such as a liquid crystal on silicon panel (LCOS panel) or a digital micro-mirror device (DMD). In some embodiments, the light valve 60 may also be a transmissive optical modulator such as a transparent liquid crystal panel, an electro-optical modulator, a magneto-optic modulator, or an acousto-optic modulator (AOM). The disclosure does not limit the form and the type of the light valve 60. Sufficient teachings, suggestions, and implementation descriptions of the detailed steps and implementations of the light valve 60 converting the illumination beam LB into the image beam LI may be obtained from common knowledge in the art, so there will be no reiteration. In the embodiment, the number of the light valve 60 may be one to three, but the disclosure is not limited thereto.

The projection lens 70 includes, for example, a combination of one or more optical lenses with refractive power, such as various combinations of non-planar lenses such as biconcave lens elements, biconvex lens elements, concave-convex lens elements, convex-concave lens elements, plano-convex lens elements, and plano-concave lens elements. In an embodiment, the projection lens 70 may further include a planar optical lens to project the image beam LI from the light valve 60 onto the projection target in a reflective manner. The disclosure does not limit the form and the type of the projection lens 70.

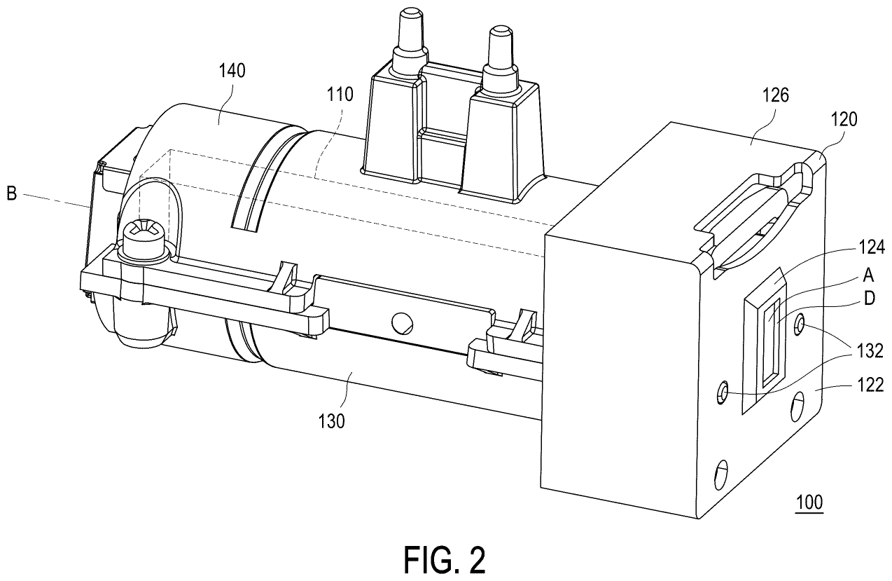

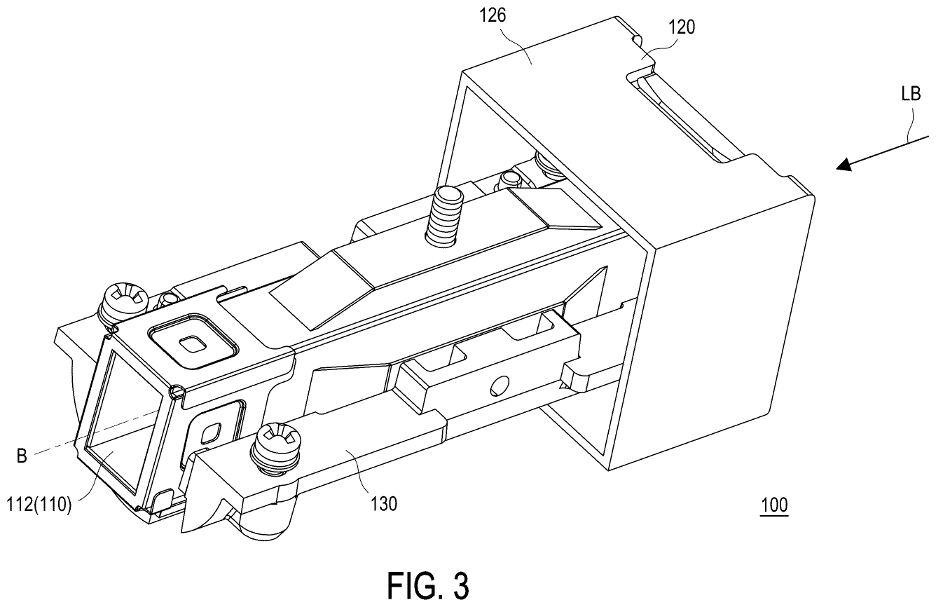

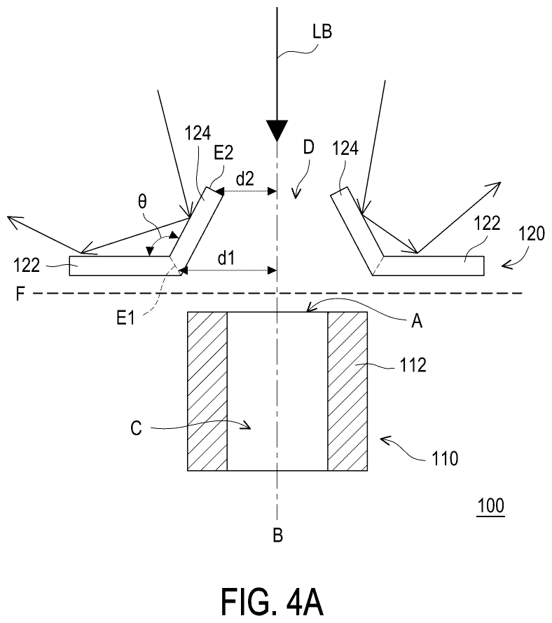

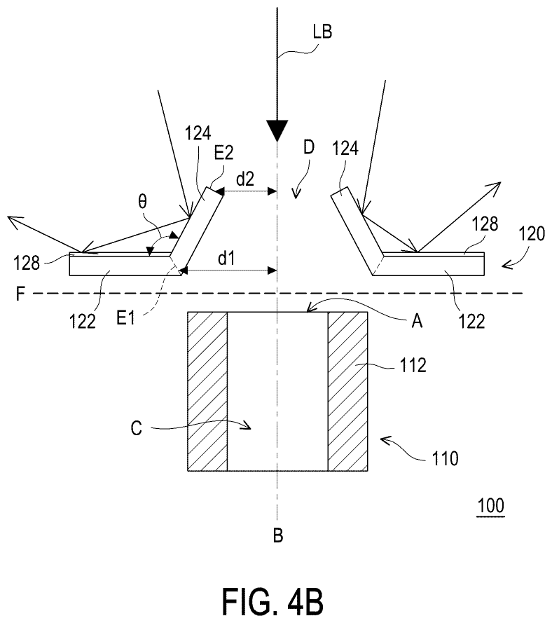

FIG. 2 and FIG. 3 are respectively schematic views of a light homogenizing module at different viewing angles according to an embodiment of the disclosure. FIG. 4A is a schematic cross-sectional view of a light homogenizing module according to an embodiment of the disclosure. The light homogenizing module 100 shown in FIG. 4A may be at least applied to the light homogenizing module 100 of FIG. 1 to FIG. 3, which is used as an example for description in the following. For the convenience of reading, a protective case 140 is omitted in FIG. 3, and FIG. 4A only shows the light homogenizing element 110 and the light shielding element 120. Please refer to FIG. 1 to FIG. 4A. In the embodiment, the light homogenizing module 100 includes the light homogenizing element 110 and the light shielding element 120. The light homogenizing element 110 includes a light incident surface A and an axis B perpendicular to the light incident surface A. Specifically, the axis B is a virtual line that passes through the geometric center of the light incident surface A and is perpendicular to the light incident surface A. The light homogenizing element 110 may be a hollow integration rod or a solid integration rod. The light homogenizing element 110 of the embodiment is explained by taking the hollow integration rod as an example. The light homogenizing element 110 includes a surrounding wall 112 and a cavity C. The cavity C is formed inside the surrounding wall 112. The light incident surface A is located at an end of the cavity C. Specifically, in the embodiment, the light homogenizing module 100 further includes a base 130 and a protective case 140. The light homogenizing element 110 is disposed on the base 130, and the protective case 140 is connected to the base 130. The interconnected protective case 140 and base 130 are used to cover the light homogenizing element 110.

The light shielding element 120 is disposed on a side of the light incident surface A of the light homogenizing element 110 and is used to block unnecessary light beams from entering the light homogenizing element 110 to improve the optical quality, wherein the illumination beam LB is incident on the light homogenizing element 110 from the incident surface A of the light homogenizing element 110, and the unnecessary light beams are, for example, reflected light or stray light generated by the illumination beam LB hitting a material section or other elements of the light homogenizing element 110. The light shielding element 120 includes a first reflection portion 122, at least one second reflection portion 124, and a light entrance D. The light entrance D exposes a part or all of the light incident surface A of the light homogenizing element 110. An extension direction of the first reflection portion 122 is parallel to the light incident surface A of the light homogenizing element 110 and surrounds the light entrance D. Specifically, in the embodiment, the light shielding element 120 further includes an extension portion 126, which extends from the first reflection portion 122 toward the light homogenizing element 110 in a direction parallel to the axis B of the light homogenizing element 110. The extension portion 126 may have a connecting structure (not shown) for connecting to the base 130, so that the light shielding element 120 is fixed to the base 130, wherein the connecting structure may be a buckle structure, but the disclosure is not limited thereto. In the embodiment, the base 130 may be further designed to include multiple positioning rods 132 that penetrate the first reflection portion 122 of the light shielding element 120 for positioning, but the disclosure is not limited thereto. To further illustrate, the extension portion 126 may, for example, surround a part of the light homogenizing element 110.

Please refer to FIG. 4B. In the embodiment, a functional film layer 128 is disposed on at least part of a surface of the first reflection portion 122 away from the light homogenizing element 110, wherein the functional film layer 128 is, for example, a light absorbing layer or a diffuse reflection layer. The light absorbing layer is, for example, a black coating, an anodized layer, or an anti-reflective coating. Specifically, the light absorbing layer may be formed by coating black pigment on the surface, anodizing the surface, or coating the surface with an anti-reflective coating. The diffuse reflection layer is a coating with diffuse reflection particles added or a structural layer with a rough surface formed by atomized sandblasting, but the disclosure is not limited thereto.

Please refer to both FIG. 4A and FIG. 4B. The at least one second reflection portion 124 has a first end portion E1 and a second end portion E2 opposite to each other. The first end portion E1 of the at least one second reflection portion 124 is connected to the first reflection portion 122, and the second end portion E2 of the at least one second reflection portion 124 is farther away from the light homogenizing element 110 than the first reflection portion 122. In a direction parallel to the light incident surface A of the light homogenizing element 110, a distance d2 between the second end portion E2 of the at least one second reflection portion 124 and the axis B is less than or equal to a distance d1 between the first end portion E1 of the at least one second reflection portion 124 and the axis B. Specifically, in the embodiment, the second reflection portion 124 is a gradually expanding opening from the second end portion E2 toward the first end portion E1, and a surface of the second reflection portion 124 along the second end portion E2 toward the first end portion E1 forms an included angle θ with a surface of the first end portion E1 away from the light homogenizing element 110 at the first end portion E1, wherein the included angle θ may be between 90 degrees and 165 degrees.

In addition, on a virtual plane F parallel to the light incident surface A, an orthographic projection of the at least one second reflection portion 124 on the virtual plane F at least partially overlaps with an orthographic projection of the surrounding wall 112 on the virtual plane F. Alternatively, on the virtual plane F parallel to the light incident surface A, the orthographic projection of the second reflection portion 124 on the virtual plane F does not overlap with an orthographic projection of the cavity C on the virtual plane F. In the embodiment of the solid light homogenizing element 110, the orthographic projection of the at least one second reflection portion 124 on the virtual plane F also at least partially overlaps with an orthographic projection of the light homogenizing element 110 on the virtual plane F, and the overlapping area is less than or equal to 20% of the area of the orthographic projection of the light homogenizing element 110 on the virtual plane F. In the embodiment, similar to the functional film layer 128 disposed on the first reflection portion 122 (see FIG. 4B), at least part of a surface of the at least one second reflection portion 124 may also have a functional film layer, such as a light absorbing layer or a diffuse reflection layer. Furthermore, in an embodiment, the at least one second reflection portion 124 surrounds the light entrance D, and the at least one second reflection portion 124 is located at at least one edge of the light entrance D. That is to say, the second reflection portion 124 may be designed to completely surround the light entrance D or partially surround the light entrance D according to different situations. In this way, when the illumination beam LB enters the light homogenizing module 100, the reflection direction of the unnecessary light in the illumination beam LB may be changed by the design of the light shielding element 120 as shown in FIG. 4A or the unnecessary light in the illumination beam LB may be absorbed or diffused by the design of the light shielding element 120 to reduce stray light in the light path returning to the illumination system 50, thereby reducing the degree of energy absorption of the optical element in the illumination system 50 to lower the temperature of the optical element and increase the service life.

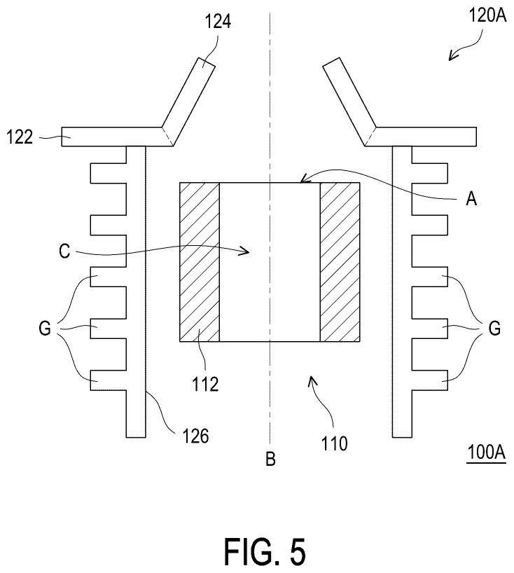

FIG. 5 is a schematic cross-sectional view of a light homogenizing module according to another embodiment of the disclosure. Please refer to FIG. 5. A light homogenizing module 100A of the embodiment is similar to the light homogenizing module 100 shown in FIG. 4A. The difference between the two is that in the embodiment, a light shielding element 120A of the light homogenizing module 100A also includes multiple heat dissipation fins G. The heat dissipation fins G are disposed on the extension portion 126 and extends along a direction perpendicular to the axis B. In this way, the heat dissipation effect of the light homogenizing module 100A can be increased, thereby maintaining good optical quality.

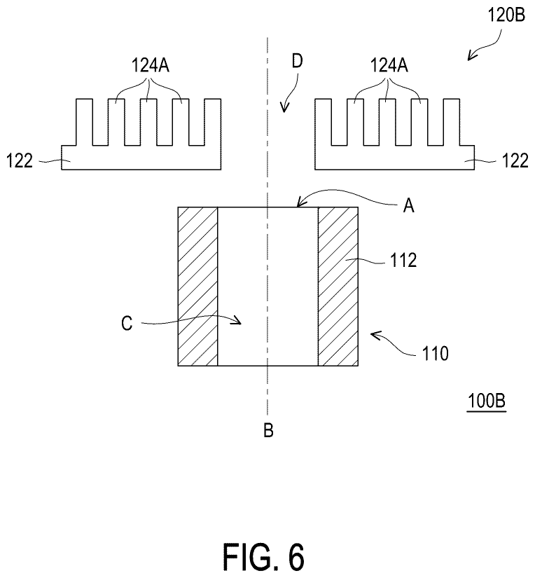

FIG. 6 is a schematic cross-sectional view of a light homogenizing module according to another embodiment of the disclosure. Please refer to FIG. 6. A light homogenizing module 100B of the embodiment is similar to the light homogenizing module 100 shown in FIG. 4A. The difference between the two is that the number of second reflection portions 124A in a light shielding element 120B of the light homogenizing module 100B is multiple, and the second reflection portions 124A are disposed at intervals on the first reflection portion 122 to form a fin structure in the embodiment. Specifically, in the embodiment, the first reflection portion 122 and each of the second reflection portions 124A are perpendicular to each other. In other embodiments, each of the second reflection portions 124A may also be inclined toward the axis B or away from the axis B relative to the first reflection portion 122. In this way, the heat dissipation effect of the light homogenizing module 100B can be increased, thereby maintaining good optical quality. In addition, in other embodiments, an outer surface of each of the second reflection portions 124 may also have a functional film layer (as shown in FIG. 4B), such as a light absorbing layer or a diffuse reflection layer, to reduce the generation of stray light. However, the disclosure is not limited thereto.

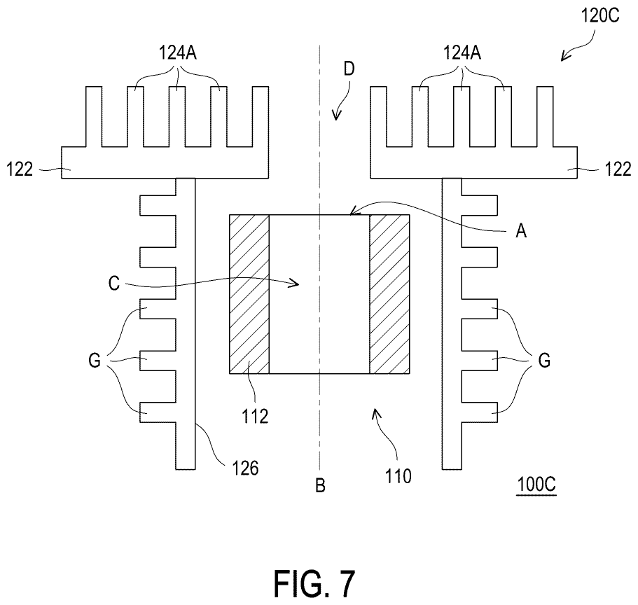

FIG. 7 is a schematic cross-sectional view of a light homogenizing module according to another embodiment of the disclosure. Please refer to FIG. 7. A light homogenizing module 100C of the embodiment is similar to the light homogenizing module 100 shown in FIG. 4A. The difference between the two is that in a light shielding element 120C of the light homogenizing module 100C of the embodiment, the extension portion 126 is provided with multiple heat dissipation fins G, which is similar to the light homogenizing module 100A shown in FIG. 5. A second reflection portion 124A adopts the second reflection portion 124A of FIG. 6, the number of the second reflection portions 124A is multiple, and the second reflection portions 124A are disposed at intervals on the first reflection portion 122 to form a fin structure. In this way, the heat dissipation effect of the light homogenizing module 100C can be increased, thereby maintaining good optical quality.

In summary, the embodiments of the disclosure have at least one of the following advantages or effects. In the light homogenizing module and the projection device of the disclosure, the light homogenizing module includes the light homogenizing element and the light shielding element disposed on a side of the light incident surface of the light homogenizing element. The light shielding element includes the first reflection portion, the at least one second reflection portion, and the light entrance. The second reflection portion has the first end portion and the second end portion opposite to each other, the first end portion is connected to the first reflection portion, and the second end portion is farther away from the light homogenizing element than the first reflection portion. The light homogenizing element includes the axis perpendicular to the light incident surface, and in the direction parallel to the light incident surface, the distance between the second end portion and the axis is less than or equal to the distance between the first end portion and the axis. In this way, the reflection direction of light may be changed by the design of the light shielding element to reduce stray light in the light path returning to the illumination system, thereby reducing the degree of energy absorption of the optical element in the illumination system to lower the temperature of the optical element and increase the service life.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the present disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the disclosure as defined by the following claims. Moreover, no element and component in the disclosure is intended to be dedicated to the public regardless of whether the element or component is explicitly recited in the following claims.

What is claimed is:

1. A light homogenizing module, comprising a light homogenizing element and a light shielding element, wherein:
the light homogenizing element comprises a light incident surface and an axis perpendicular to the light incident surface; and
the light shielding element is disposed on a side of the light incident surface, and the light shielding element comprises a first reflection portion, at least one second reflection portion, and a light entrance, wherein:
the first reflection portion surrounds the light entrance;
the at least one second reflection portion has a first end portion and a second end portion opposite to each other, the first end portion of the at least one second reflection portion is connected to the first reflection portion, and the second end portion of the at least one second reflection portion is farther away from the light homogenizing element than the first reflection portion; and
the light entrance exposes the light incident surface;
wherein an extension direction of the first reflection portion is parallel to the light incident surface, and in a direction parallel to the light incident surface, a distance between the second end portion of the at least one second reflection portion and the axis is less than or equal to a distance between the first end portion of the at least one second reflection portion and the axis.

2. The light homogenizing module according to claim 1, wherein the light homogenizing element further comprises a surrounding wall and a cavity, the cavity is formed inside the surrounding wall, the light incident surface is located at an end of the cavity, and on a virtual plane parallel to the light incident surface, an orthographic projection of the at least one second reflection portion on the virtual plane at least partially overlaps with an orthographic projection of the surrounding wall on the virtual plane.

3. The light homogenizing module according to claim 1, wherein the light homogenizing element further comprises a surrounding wall and a cavity, the cavity is formed inside the surrounding wall, the light incident surface is located at an end of the cavity, and on a virtual plane parallel to the light incident surface, an orthographic projection of the at least one second reflection portion on the virtual plane does not overlap with an orthographic projection of the cavity on the virtual plane.

4. The light homogenizing module according to claim 1, wherein the at least one second reflection portion surrounds the light entrance, and the at least one second reflection portion is located at at least one edge of the light entrance.

5. The light homogenizing module according to claim 1, wherein a number of the at least one second reflection portion is plural, and the second reflection portions are disposed at intervals on the first reflection portion to form a fin structure.

6. The light homogenizing module according to claim 5, wherein the first reflection portion and each of the second reflection portions are perpendicular to each other.

7. The light homogenizing module according to claim 1, wherein at least part of a surface of the first reflection portion away from the light homogenizing element has a light absorbing layer or a diffuse reflection layer.

8. The light homogenizing module according to claim 1, wherein at least part of a surface of the at least one second reflection portion has a light absorbing layer or a diffuse reflection layer.

9. The light homogenizing module according to claim 8, wherein the light absorbing layer is a black coating, an anodized layer, or an anti-reflective coating, and the diffuse reflection layer is a coating with diffuse reflection particles or a structural layer with a rough surface.

10. The light homogenizing module according to claim 1, wherein the light shielding element further comprises an extension portion, the extension portion extends from the first reflection portion toward the light homogenizing element in a direction parallel to the axis of the light homogenizing element.

11. The light homogenizing module according to claim 10, wherein the light shielding element further comprises a plurality of heat dissipation fins, and the plurality of heat dissipation fins are disposed on the extension portion.

12. A projection device, comprising an illumination system, at least one light valve, and a projection lens, wherein:
the illumination system is used to provide an illumination beam;
the at least one light valve is disposed on a transmission path of the illumination beam from the illumination system and is used to convert the illumination beam into an image beam; and
the projection lens is disposed on a transmission path of the image beam and is used to project the image beam out of the projection device,
wherein the illumination system comprises a light source module and a light homogenizing module, the light source module is used to provide the illumination beam, the light homogenizing module is disposed on the transmission path of the illumination beam and is used to receive and homogenize the illumination beam, and the light homogenizing module comprises a light homogenizing element and a light shielding element, wherein:
the light homogenizing element comprises a light incident surface and an axis perpendicular to the light incident surface; and
the light shielding element is disposed on a side of the light incident surface, and the light shielding element comprises a first reflection portion, at least one second reflection portion, and a light entrance, where:
the first reflection portion surrounds the light entrance;
the at least one second reflection portion has a first end portion and a second end portion opposite to each other, the first end portion of the at least one second reflection portion is connected to the first reflection portion, and the second end portion of the at least one second reflection portion is farther away from the light homogenizing element than the first reflection portion; and
the light entrance exposes the light incident surface, wherein an extension direction of the first reflection portion is parallel to the light incident surface, and in a direction parallel to the light incident surface, a distance between the second end portion of the at least one second reflection portion and the axis is less than or equal to a distance between the first end portion of the at least one second reflection portion and the axis.

13. The projection device according to claim 12, wherein the light homogenizing element further comprises a surrounding wall and a cavity, the cavity is formed inside the surrounding wall, the light incident surface is located at an end of the cavity, and on a virtual plane parallel to the light incident surface, an orthographic projection of the at least one second reflection portion on the virtual plane at least partially overlaps with an orthographic projection of the surrounding wall on the virtual plane.

14. The projection device according to claim 12, wherein the light homogenizing element further comprises a surrounding wall and a cavity, the cavity is formed inside the surrounding wall, the light incident surface is located at an end of the cavity, and on a virtual plane parallel to the light incident surface, an orthographic projection of the at least one second reflection portion on the virtual plane does not overlap with an orthographic projection of the cavity on the virtual plane.

15. The projection device according to claim 12, wherein the at least one second reflection portion surrounds the light entrance, and the at least one second reflection portion is located at at least one edge of the light entrance.

16. The projection device according to claim 12, wherein a number of the at least one second reflection portion is plural, and the second reflection portions are disposed at intervals on the first reflection portion to form a fin structure.

17. The projection device according to claim 16, wherein the first reflection portion and each of the second reflection portions are perpendicular to each other.

18. The projection device according to claim 12, wherein at least part of a surface of the first reflection portion away from the light homogenizing element has a light absorbing layer or a diffuse reflection layer.

19. The projection device according to claim 12, wherein at least part of a surface of the at least one second reflection portion has a light absorbing layer or a diffuse reflection layer.

20. The projection device according to claim 19, wherein the light absorbing layer is a black coating, an anodized layer, or an anti-reflective coating, and the diffuse reflection layer is a coating with diffuse reflection particles or a structural layer with a rough surface.

21. The projection device according to claim 12, wherein the light shielding element further comprises an extension portion, the extension portion extends from the first reflection portion toward the light homogenizing element in a direction parallel to the axis of the light homogenizing element.

22. The projection device according to claim 21, wherein the light shielding element further comprises a plurality of heat dissipation fins, and the plurality of heat dissipation fins are disposed on the extension portion.
